(19) United States
(12) Patent Application Publication
(10) Pub. No.: US 2011/0080809 A1
(43) Pub. Date: Apr. 7, 2011

(54) Personalized Children's Multimedia Picture Alarm

(76) Inventor: Michele Berman, Chicago, IL (US)

(21) Appl. No.: 12/722,178

(22) Filed: Mar. 11, 2010

Related U.S. Application Data
(60) Provisional application No. 61/249,401, filed on Oct. 7, 2009.

(51) Int. Cl. G04G 9/00; G04B 47/00; G04G 13/02; G04G 21/00

(52) U.S. Cl. 368/10; 368/224

(57) ABSTRACT

A new child-friendly multimedia clock design consists in a preferred embodiment of child-friendly, durable material with no hard corners, sized to comfortably sit on a child's nightstand but large enough for the clock and photo to be easily seen. The frame includes a photo space to provide an easily decodable electronic photo image that instructs the child to get up or to stay in bed. The photos used are changed digitally without the use of a mechanical rotating faceplate or cylinder, and may be user-provided images such as family photographs etc. In an embodiment of the invention, the lighting of the image occurs gradually so that no light appears suddenly to wake the child unnecessarily. In one embodiment, music is also provided via an internal memory, external card slot, or a docked audio device such as an MP3 player.

### CROSS-REFERENCE TO RELATED APPLICATION

This application claims the benefit of U.S. Provisional Patent Application No. 61/249,401, filed on Oct. 7, 2009, the contents of which are hereby incorporated by reference in its entirety.

### FIELD OF THE INVENTION

The invention pertains generally to alarm clocks and, more particularly to an improved children's alarm clock that conveys time periods via user-customized pictorial cues instead of or in addition to ordinary time indicators.

### BACKGROUND OF THE INVENTION

Children between the ages of 2 and 5 have difficulty reading traditional clocks, and are also generally disinclined to remain in bed until a reasonable waking hour. Even if a child is able to understand that they should stay in bed until the displayed time begins with a “6”, there may be no differentiating between 6:01 and 6:59. To parents, this is a significant difference and represents a much-needed hour of sleep. This problem can become worse in the summer months when the sun “wakes-up” earlier and bedtime seems to be, or actually is, later. In these summer hours, a child may awake and leave the bed before 5:00 in the morning simply because the sky is light and therefore the child feels that it must be time to get up.

Although this is a persistent and long-standing problem, the art has developed no effective solution. For example, U.S. Publication 20050117458 attempts to address the problem but contains a dial that has to be removed physically and can be changed only by removing it and then replacing it. The dial can be easily damaged or even destroyed as children play with this removable piece. As a further example, U.S. Publication 20020126580 also contains a dial that rotates. Similarly, a children's illustrative night and day clock discussed in U.S. Publication 20080084790 uses a faceplate comprising a translucent material and a video system for displaying a visual image on the faceplate. This clock produces sounds and visual images associated with day and night. The faceplate has both moon and sun-like images displayed on the faceplate which are capable of being illuminated at specific times. Other examples of similar mechanisms include U.S. Pat. No. 6,361,325 and U.S. Pat. No. 6,392,963.

### SUMMARY OF THE INVENTION

Young children need a simple, clear mechanism to allow them to determine whether it is time get up or it is time to stay in bed and try to fall back asleep. An easily understandable visual image that is pleasant, consistent and easily understood will work for children to comprehend this difference. In this way, children who are over-tired or awake too early will know that they should go back to sleep and not get out of bed. At the very least, they will know by this visual that they need to stay on their beds until the visual indicates that it is morning and time to get up and start the day.

Young children respond to simple visuals that cue consistent easily understood elements. For example, a sun with open eyes means awake and daytime, while a moon with closed eyes indicates sleep, or “stay in bed” time. Slightly older children can understand a more complicated but still consistent visual to indicate morning or evening. For example, a photograph of children sleeping in sleeping bags can mean bedtime and kids jumping rope on the sidewalk can indicate morning time. Such wake up cues can be more meaningful when they include familiar people, places an objects, e.g., family members, pets, etc.

This invention provides a multi-media awakening experience, allowing a child to wake-up, look at the clock and see not only a digital clock display but also a clear digital photo/image of a familiar or otherwise user-customized image that indicates morning/up-time or nighttime/stay in bed. In other words, the child knows to get out of bed if the photo/image is the “wake-up” photo, and they should remain in bed if the photo/image is the nighttime image. In an embodiment of the invention, the photo/image is displayed clearly on the face of the clock directly above the digital or analog time display. In a further embodiment, the multi-media experience is extended to include an audio experience via the playing of music that may be downloaded to or imported into the device.

In an embodiment, this device consists of child-friendly, durable material with no hard external corners. The frame maintains soft, rounded edges and appears child-friendly in color, design and shape in this embodiment. The frame may consist of a hard elastomeric material such as thermoplastics, resin, etc. In one embodiment of the invention, the frame periphery is removable so that other frame peripheries can be purchased separately in different colors/patterns to be “popped” on as the child matures. The frame may also accommodate various “skins” so that the parent and/or child may customize the appearance further. For example, the device may accommodate a sports themed skin, a movie themed skin, a character themed skin, or any other suitable skin, including a writable skin in an embodiment. Skins may also be provided in solid and patterned designs.

In an embodiment, the device is small enough to sit on a child's nightstand next to a bed but large enough for the clock and photo to be easily seen and recognized at a glance. In another embodiment, the device is sized so that its display elements are visible from across a room. In yet another embodiment, the device is provided in a miniature size, e.g., about three inches or less in length and width. In this embodiment, the device may also be foldable or comprise a foldable or slidable portion or cover. The photo space size depends upon the size of the device, but is sufficient to hold a 3×5 photo in a desktop embodiment of the invention, but other embodiments accommodate any other desired image size such as 5×7 or other larger or smaller standard or nonstandard size.

Advantages over prior art are many, but include primarily easily decodable user-custom photo images that a child can see clearly to determine if it is time to get up or stay in bed. The photos change digitally without the noise and complication caused by a mechanical rotating faceplate or cylinder. Further, in an embodiment, the lighting of the image occurs gradually so that no light appears suddenly to wake the child unnecessarily. Moreover, there are no mechanical image carriers to be easily damaged while physically changing. The digital display is easy to read so the child can learn to tell time alongside the photo/image display. The ability to load personal photos allows the use of images that resonate specifically with one's child. This product also appeals to a broad range of ages. As the child matures and learns to tell time, the photo space can be used as a photo frame that can house personal rotating photos.

### BRIEF DESCRIPTION OF THE SEVERAL VIEWS OF THE DRAWINGS

FIG. 1 illustrates a front perspective view of the device during awake hours;

FIG. 2 illustrates a front perspective view of the device during asleep hours;

FIG. 3 illustrates the back-side view perspective of the device;

FIG. 4 illustrates the side-view perspective of the device set to wake-up;

FIG. 5 illustrates the features of the main unit control panel in the shape of a dial;

FIG. 6 Illustrates a second design option for the main control panel in a vertical slide format and the control unit set to “photo alarm 1”;

FIG. 7 illustrates a third design option for the main control unit separating the unit by device modes and setting features into two vertical slide formats; and

FIG. 8 shows an embodiment of the invention wherein the clock has a vertical format.

### DETAILED DESCRIPTION OF THE INVENTION

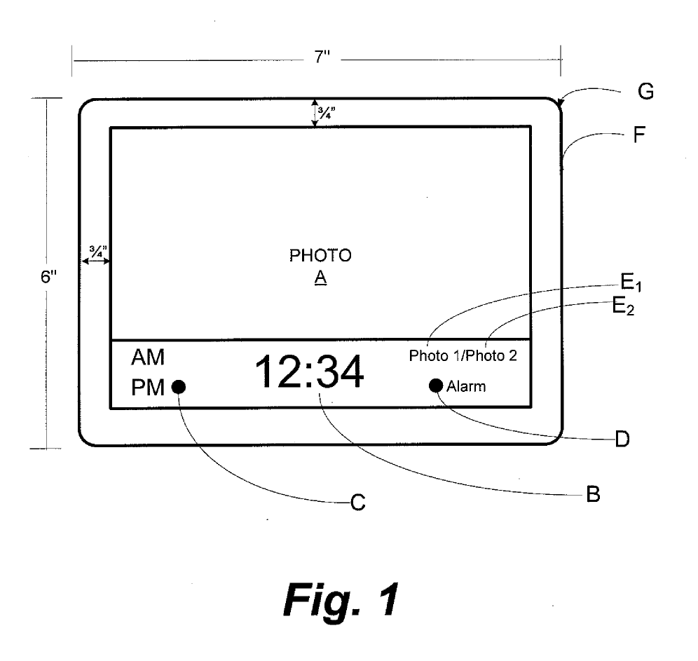

FIG. 1 illustrates a front view of an embodiment of the invention, as it appears during awake hours. The front of the device has a large space (A) allocated for a photo/image display. The photo/image space takes up the largest portion of the face of the device. The design allows for horizontal images to be selected from the pre-programmed photo/image choices, but also allows personal photos to be added into the device. As noted above, the space (A) is physically sized to display a photo in one configuration. Regarding physical size and storage requirements, it will be appreciated that higher resolution, which may be desired for larger image size, will require sufficient memory resources. The screen resolution will limit the maximum displayable resolution, but in an embodiment, the display area is able to display the highest available resolutions, e.g., 12 Mp or more, depending upon design preference. The rendered version of the photo need not have precisely the same dimensions as the original version of the photo unless identical resolution is desired. The digital clock, B, represents the actual time of day in a conventional manner.

There are indicators (C) in this section of the device to indicate whether it is morning (AM) or afternoon/evening (PM), as well as an indicator (D) to identify whether an audible alarm has been set. The indicator E1 showing if photo 1 is selected appears in the right-hand corner of the digital clock display. The indicator E2 showing if photo/image 2 is selected is shown in the digital clock display directly next to the photo 1 indicator, E1. If a pre-programmed “set” of photos/images is selected, the E1 and E2 indicators appear together automatically.

The frame (F) of the device may have an even width around the clock and photo/image space, such that the frame acts as a photo frame. In an embodiment of the invention, this frame is made of durable, child-friendly material and has rounded “soft” corners with no hard/sharp edges, G.

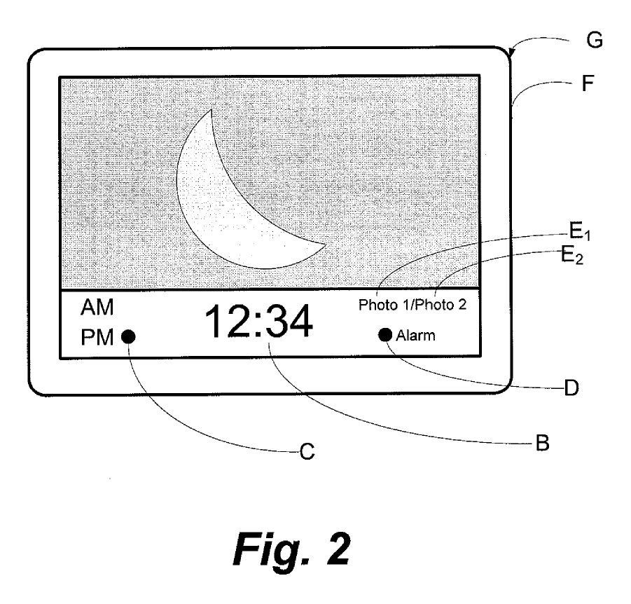

FIG. 2 shows the allocated space (A) as it might appear at a time when the mode has changed from the daytime photo to the pre-programmed or selected nighttime photo. In the illustrated embodiment of the invention, the night time photo is of a crescent moon, but other suitable images may be used instead. Although the images are discussed herein as photos, it will be appreciated that nonphotographic images may be used instead without departing from the principles of the invention. In any case, it is desirable that the device be able to import user-provided images, whether photographic or otherwise.

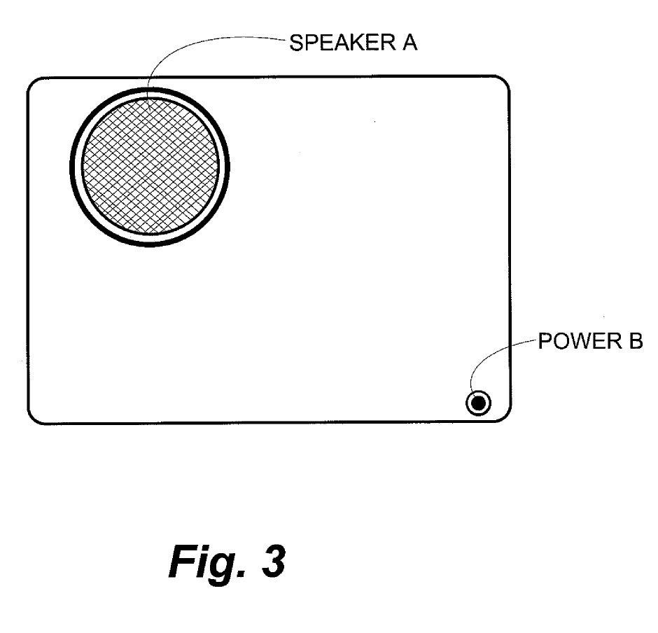

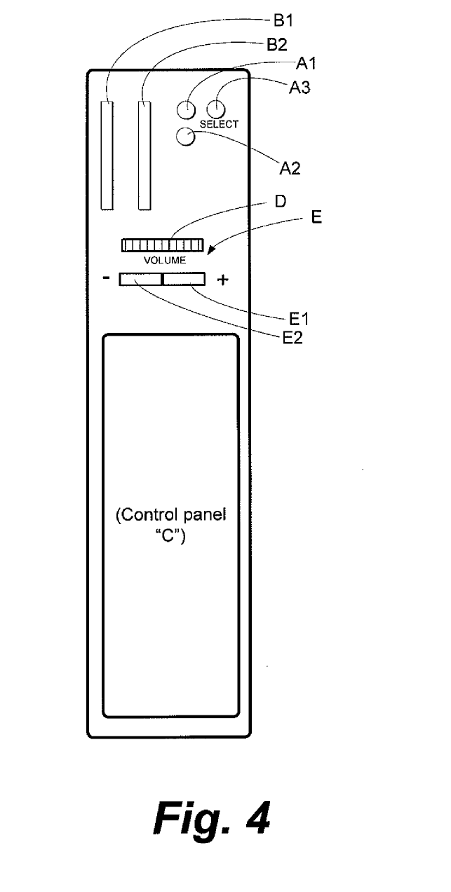

FIG. 3 illustrates a back surface of the device. Although there are numerous possibilities for feature placement on the rear surface, the illustrated embodiment includes a speaker (A) and a power receptacle (B). The speaker is an audio outlet that allows for the alarm to sound if programmed to be used. This configuration also allows the device to provide a multi-media experience to the child by playing music and other sounds. An internal memory, memory card, or other data source may be used to provide audio data, i.e., music, and may be turned on at will or programmed to be turned on (see FIG. 4). In a further embodiment, the device provides a docking station or port for another audio device such as an MP3 player or otherwise, so that the device can act as a speaker/amplifier for the device, and/or may download content from the attached audio unit to the device for later playing.

In an alternative embodiment of the invention, the speaker is omitted and an internal piezo electric or other element is used to produce and audible alarm if desired.

The power receptacle B allows the device to be powered by an external power source. In an embodiment of the invention, the device is additionally or alternatively powered by a battery to allow portability or use at a location that is too far from a household power socket. This will be especially useful in the design of a travel-sized device. It will be appreciated that many other features may reside on the back of the device, including a reset button, optional battery bay, folding frame stand, etc.

In an embodiment of the invention, a clock as described above is provided in a smaller travel size, e.g., in a folding case of 3″×3″ or less. Within this embodiment, the folding or sliding cover as mentioned above in overview may also function as a stand element to hold the clock upright. It will be appreciated that in this portable embodiment, the device will have less surface area and will thus have less space for presenting user options. Because of this, the display area may be smaller, and the number of buttons may be limited, with multi-tap and/or scrolling user interface techniques being used where needed to eliminate discrete controls and buttons.

Moreover, it will be appreciated that in an embodiment of the invention, most or all of the user-activated controls are touch screen, touch panel, or other touch sensitive elements, instead of physically movable buttons, switches, and/or sliders. In a particular embodiment, a physically actuated on/off control is provided and all other user-activated controls are “soft keys,” i.e., touch sensitive or touch screen controls. This embodiment may be applied to any size device whether full-sized, oversized, or even travel-sized.

Returning to the full-sized embodiment, FIG. 4 illustrates the right-side view of the device described in FIG. 3. This side of the device houses the user-actuated controls. The control elements displayed in FIG. 4 need not reside at the exact location shown, and indeed may be moved as needed or desired in any particular implementation. Moreover, the control panel shown here in FIG. 4 is merely an example, and it will be appreciated that a given implementation may use only a subset of the illustrated controls and/or may use additional control elements not shown.

The illustrated control panel consists of several elements. The first section, A, allows for the user to scroll through and select the photos/images for the device. It is envisioned that the device may be sold pre-loaded with 3 to 4 “sets” of preloaded images, although it is important for the device to also have the ability to receive/import user-provided images. With respect to the preloaded sets, each set will include an image/photo signaling “awake” and an image/photo signaling “asleep.” The images targeted towards the younger children, e.g., 2 through 4 years old, may be youthful illustrations, while the images targeting older children, e.g., 5 and 6 year-olds, could be either illustrations or actual photos. By pressing the button, A1, the user can scroll through the selection of pre-loaded images/photos. When finding an appropriate choice, such a moon with closed eyes for asleep or a sun with open eyes for awake, the user can press button A3 to select that photo/image or set of photos/images for use. Alternatively, the user can use button A2 to scroll through photos that have been personally loaded in the manner explored further below. Again, button A3 would be pressed to select one of these photos.

The control panel also includes slots for 2 media cards B. By way of example, B1 may allow the user to input personal photos into the device. The media card may be an SD card or other suitable card, and is preferably of sufficient capacity to hold at least two images, and preferably more. In an embodiment of the invention, the slot B1 is a USB port for receiving a flash drive. The images may be stored in any suitable format, e.g., PEG, TIFF, PDF, etc., and the image data should be horizontal (landscape) in nature based on the illustrated design. However, in a further embodiment of the invention, the screen aspect ratio is such that vertical photos to be used additionally or alternatively. In another embodiment, only a single input port is provided, e.g., for media cards or USB connectors, but not both. In a further embodiment, hardware ports are omitted and content is transferred to the device wirelessly, e.g., via Bluetooth or other RF or optical communication mechanism.

In another embodiment of the invention, the device contains a gravity or contact sensor, or a switch, such that when the device is turned on end, the face, which is an LCD panel or other suitable flat panel display device, is reformed so that the components from FIGS. 1A, B, C, D and E all rotate so that the photo frame F would sit vertically for the child to view.

Returning to the elements of FIG. 4, the slot B2, when provided, is adapted to receive a media card or flash drive to allow a user to input music to the device. The media device used with slot B2 is preferably of sufficient capacity to hold multiple standard length tracks, but may also be used to provide media for repeating or looped tracks such as wave sounds, wind sounds, etc. The audio data can be played by switching a dial (not shown) to “Music” and turning a volume dial (not shown) up, as needed. In an embodiment, the input audio, e.g., music, is also used to provide the audio component of an audio alarm if set by the user.

Volume dial D is a “roll-over” dial or other hardware or touch-sensitive interface element that allows the user to turn up the volume by moving to the right or turning down the volume by moving to the left. When the dial is turned all the way to the left position, there is no sound at all from the device.

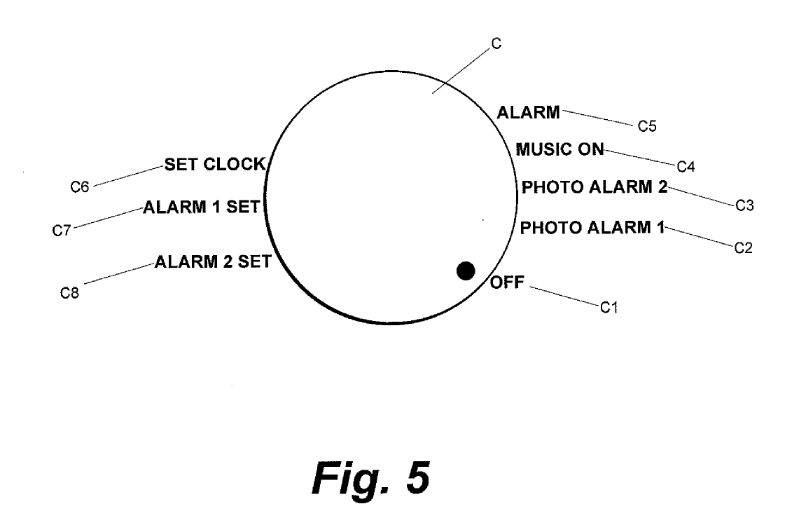

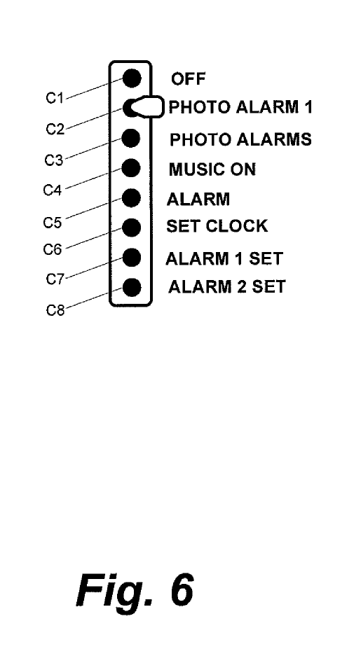

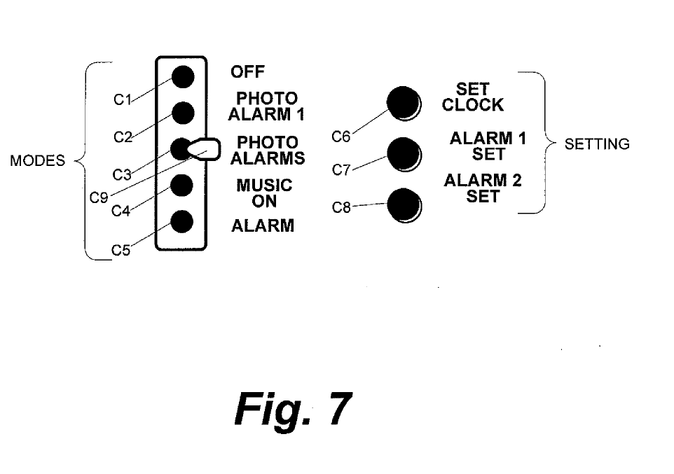

Below the volume dial, D, is the control for setting the time, E. This control adjusts the time forward, E1, or backwards, E2, when programmed by the user. This feature of the device is necessary for setting the clock time, C6, the alarm 1 time, C7, and the alarm 2 time, C8. These features C6, C7, and C8 are all explored further in the following FIG. descriptions FIG. 5, FIG. 6 and FIG. 7.

Referring to FIG. 5, the control dial, C, is the main control feature on the control panel. This dial can be set in any of several positions by the user to set the device into action. The “Off” feature, C1, is set when the clock is not set up to act as a visual or audio alarm. The device is also set to Off, C1, when music is not being played. The control dial is turned to C2 (bedtime photos on) when the user would like the nighttime photo/image to appear at a pre-selected time in the evening and the daytime photo/image to re-appear at the pre-set time.

The control dial C allows for both the nighttime and naptime features of the alarm system to be deployed. This naptime dial setting C3 allows for a second time period when the pre-set or selected photos/images change to indicate awake or asleep time. This setting is the perfect solution for an afternoon nap period for a child. A typical 2-4 year-old may nap from approximately 1:00-3:00 every afternoon. A parent can set the clock for the images the child understands and then stays in their bed for naptime. Additionally the control C can be set to simply play music, C4. In this case, the user may have inserted a media card into slot, B2, and then selected music, C4, on the control panel, C.

On the left-hand side of the dial, the user can set the alarms and the clock of the device. The Clock can be set, C6, by turning the dial to C6 and then moving the time forward or backwards by compressing the E button in the appropriate direction. The alarm set features work the same way. The dial is turned to the alarm set 1, C7 or alarm set 2, C8, and then button, E is pressed to set the alarm times as chosen by the user. An alarm setting C5 is used to set the clock in the alarm state such that when the set time arrives, the selected mode of alarm is given.

Referring now to FIG. 6, the control dial, C is represented in a vertical slide format according to a further embodiment of the invention. This version includes a “button,” C9, that slides up and down the vertical operating selections. In this figure, the device is set to “Photo alarm 1,” C2.

Continuing on to FIG. 7, the control dial, C, is divided into two vertical sections. One side houses the operating modes, C1-C5. This side is a slide feature and is set to “photo alarms” C3. The “button,” C9 slides up and down and sits on the user's operating selection. The other side houses the setting features, C6-C8. When a setting is being set by the user, the user will press the appropriate button next to choices C6-C8 while adjusted the time, E, forward or backwards.

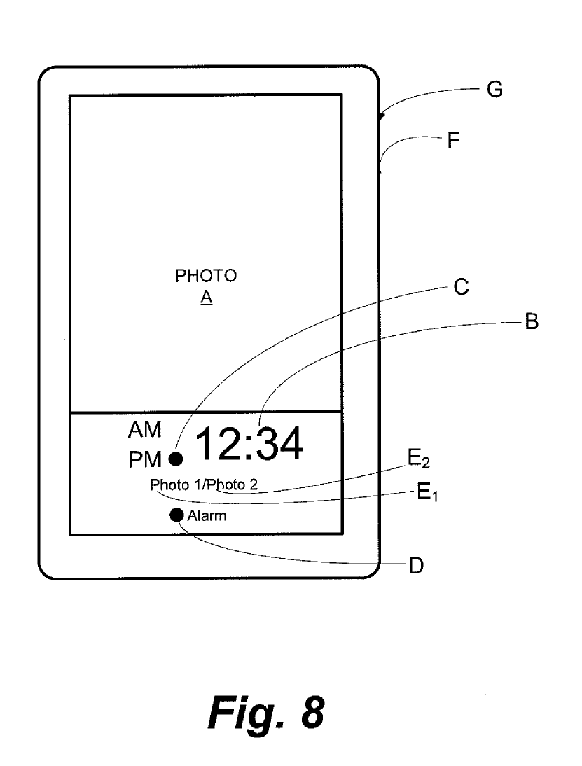

FIG. 8 shows an embodiment of the invention wherein the clock has a vertical format. In particular, the image, which may still be 3″×5″ if desired, or other suitable size, is now presented in a portrait orientation, and certain of the graphical user interface elements are sited to accommodate the vertical format rather than the horizontal format. Nonetheless, the control and display elements that are provided may be of the same type as shown in FIG. 1, as indicated by the identical reference characters.

It will be appreciated that a new and useful Personalized Children's Picture Alarm has been described and enabled herein. All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A child-friendly clock device for conveying waking time to children, the clock device comprising:
a frame;
a photo area within the frame for displaying a digital image;
an image input mechanism for receiving image data from a user; and
a controller for receiving a user selection of two or more images and for receiving at least one alarm time, the controller being adapted to switch a display in the photo area at the alarm time from a first one of the images, which indicates night time, to a second one of the images, indicating day time.

2. The child-friendly clock device according to claim 1, wherein the controller is further adapted to switch the display in the photo area back at a second time from the second one of the images to the first one of the images.

3. The child-friendly clock device according to claim 1, wherein the photo area comprises a digital screen.

4. The child-friendly clock device according to claim 1, wherein the image data comprises data representative of one or more photographs.

5. The child-friendly clock device according to claim 1, further comprising a user input device for selecting the at least one alarm time.

6. The child-friendly clock device according to claim 5, wherein the user input device for selecting the at least one alarm time is a touch screen, touch panel, or other touch sensitive element.

7. The child-friendly clock device according to claim 5, wherein the user input device for selecting the at least one alarm time is a physically actuated button.

8. The child-friendly clock device according to claim 1, further comprising an audio device for producing a human audible signal.

9. The child-friendly clock device according to claim 8, wherein the audio device for producing a human audible signal is a speaker element, and wherein the controller is adapted for reading data representative of music and for causing the speaker element to emit an audible reproduction of the read data.

10. The child-friendly clock device according to claim 1, further comprising a clock region for displaying a time of day in an hour and minute format.

11. The child-friendly clock device according to claim 10, wherein the clock region is adapted for displaying the time of day in a digital format.

12. The child-friendly clock device according to claim 10, wherein the clock region is adapted for displaying the time of day in an analog format.

13. The child-friendly clock device according to claim 1, wherein the device includes a cover portion for covering a portion of the device in a closed position, and for supporting the device for use in a second position.

14. The child-friendly clock device according to claim 1, further comprising a sensor for sensing an orientation of the device, wherein the controller is adapted to read the sensed orientation and adjust a display within the photo area based on the sensed orientation.

15. The child-friendly clock device according to claim 9, further comprising a port for attaching a separate audio device to the child-friendly clock device.

16. The child-friendly clock device according to claim 15, wherein the port for attaching a separate audio device is adapted to receive and connect to an MP3 player device.
